(19) United States
(12) Patent Application Publication
(10) Pub. No.: US 2005/0075841 A1
(43) Pub. Date: Apr. 7, 2005

(54) Automated defect classification system and method

(76) Inventors: Netanel Peles, Ramat-Hasharon (IL); Maty Moran, Yokneam Moshava (IL); Zeev Zohar, Migdal (IL)

Correspondence Address: DANIEL J SWIRSKY, PO BOX 2345, BEIT SHEMESH, 99544, IL

(21) Appl. No.: 10/911,647

(22) Filed: Aug. 5, 2004

Related U.S. Application Data
(60) Provisional application No. 60/492,325, filed on Aug. 5, 2003.

(51) Int. Cl. G06F 15/00

(52) U.S. Cl. 702/185

(57) ABSTRACT

A system and method for automatic defect classification is provided including at least one tool handler to receive a defect result file and at least one image file from a remote defect inspection tool, a process controller to create a data set from the defect result file and at least one image file, a database including a set of automated defect classification system (CADC) session data that includes data related to the data set, and a classification engine to automatically classify defects in the data set. A system and method for an automated monitoring system is provided including a production automatic defect classification (ADC) system, a monitoring CADC, and a monitor process to compare the defect result files of the production ADC system and said monitoring CADC.

### CROSS-REFERENCE TO RELATED APPLICATIONS

This application claims the benefit of U.S. Provisional Patent Application Ser. No. 60/492,325, filed Aug. 5, 2003, entitled “ADC Control System,” and incorporated herein by reference in its entirety.

### FIELD OF THE INVENTION

The present invention relates to automatic classification of defects in general, and more particularly to classification of defects in digital images.

### BACKGROUND OF THE INVENTION

An increasingly important development is the use of digital imaging in automatic defect detection and classification. Digital imaging devices may be used to capture and possibly store images, which may then be used in the detection and classification of the defects.

For example, on a semiconductor production line (also referred to as device fabs) the monitoring of quality is important and may be achieved by defect detection and classification. The classification of defects aids in the tracking of process related problems and the identification of the root sources causing them. Early pinpointing of defect root causes is essential for maintaining high yields. This is done by systematic and routine monitoring of the defect distribution by defect class. Any deviation from equilibrium, which indicates an emerging trend, is studied in an attempt to determine potential causes, which can allow for the application of corrective measures as soon as possible reducing production process problems.

There are two major forms of classification; rough classification (also referred to as binning) which can handle a limited number of fixed defect types, and fine classification. Rough classification is insufficient for areas demanding subtle distinctions between a large numbers of possible classes. Rough classification capability is typically incorporated onto defect inspection tools and runs concurrently with the detection process. Fine classification is more flexible, is trainable by application, and can be applied to many defect types. Fine classification is typically incorporated as an add-on capability to a review tool. Nevertheless, in semiconductor production, defect review and fine classification are still performed to a large extent by human operators, who review defect images in conjunction with a defect map and classify each visible defect.

FIG. 1, to which reference is now made, is a block diagram illustration of a prior art defect classification system comprising at least one defect inspection and/or review tool 20 and a yield management system (YMS) 40. Some defect inspection and/or review tools 20 may further comprise a tool laden automatic defect classification (ADC) system 22. Such a tool is depicted as defect inspection tool 20N which comprises ADC system 22N. Images and a defect result file are output by defect inspection and/or review tool 20A (that does not comprise an ADC system 22) and are sent to YMS 40. Defect inspection and/or review tool 20N runs ADC system 22N as it detects defects and updates the defect result file to include classification results. Defect inspection and/or review tool 20N thus, outputs user pre-selected images and an updated defect result file that are sent to YMS 40. A mix of inspection and/or review tools 20 generally coexist in production environments: those with and without ADC, those of different manufacturers, tools using different scanning methods, and tools using different imaging technologies.

In the field of semiconductor production, tools comprising ADC functionality are generally used to detect and mark defects on images of sampled wafers. These tools are well know in the art and include, for example, those using various surface scanning and optical technologies such as laser scattering, bright field, dark field and SEM (scanning electron microscopy). The images of the defects which were found are then reviewed at higher magnifications by optical microscope based tools and/or SEM review tools and are classified into predefined categories. Defect detection result files generally use a known standard format result file.

Defect result files are generally then analyzed by an automated management system, for example a YMS. For the same layer and the same defect class, the YMS may combine results from different tools, not necessarily alike

An environment, which is equipped with different tools of different types from different suppliers, will generally comprise a blend of different ADC systems. This may lead to confusion and handling complexity. Since each ADC system may contain different detection and classification algorithms as well as operating method, resulting performance will be different as well. Hence, classification results tend to vary between different tools operating on the same data set. When the YMS combines the results of different tools, information may be obscured since different ADC systems often generate different classification results and hence the system as a whole may not generate consistent and reliable data.

ADC systems known in the art require a dedicated recipe for directing the classification engine operation. A recipe includes a list of parameters and associated data reflecting the optical set up and image capturing characteristics, such as magnification, pixel size, calibration related data and detection tuning along with the classification rules for each relevant defect type as defined by a particular process step (also known as a layer or level) and product (or device). The classification rules, which are included in the recipe, are determined manually or automatically by the classification system through a training session, in which a set of pre-classified images of defects from each relevant class are fed into the system. This training process, which is well known in the art, requires the collection of sample images, manually classifying them, and applying interactive fine-tuning methods to improve the classification performance. Classification performance is generally measured in terms of accuracy and purity and is summed up in a matrix known as a correlation (or confusion) matrix.

Once implemented in production, ADC may gradually degrade in performance over time. ADC must therefore be carefully monitored and retuned if it deviates from specification.

### SUMMARY OF THE INVENTION

The present invention provides a system and method of automated defect classification that overcomes the disadvantages of the prior art. A novel technique for automated defect classification is described.

In one aspect of the present invention a system for automatic defect classification is provided including at least one tool handler to receive a defect result file and at least one image file from a remote defect inspection tool, a process controller to create a data set from the defect result file and the at least one image file, a database that includes a set of central automated defect classification system (CADC) session data that includes data related to the data set, and a classification engine to automatically classify defects in the data set.

In another aspect of the present invention, the classification engine is a re-detection and classification engine.

In another aspect of the present invention, the classification engine performs feature extraction.

In another aspect of the present invention, the at least one image file further includes a corresponding difference image file.

In another aspect of the present invention, the defect result file and at least one image file relate to semiconductor fabrication.

In another aspect of the present invention, for each remote defect inspection tool there is a dedicated tool handler.

In another aspect of the present invention, the at least one tool handler is either passive or active.

In another aspect of the present invention, the remote defect inspection tool is selected from the group consisting of: an optical review tool, a SEM review tool, a UV review tool, a deep UV (DUV) review tool, a bright field review tool, an optical inspection tool, a SEM inspection tool, a UV inspection tool, a DUV inspection tool, and a bright field inspection tool.

In another aspect of the present invention a central automated defect classification system is provided including at least one tool handler to receive a defect result file and at least one defect vector from a remote defect inspection tool, a process controller to create a data set from the defect result file and the at least one defect vector, a database that includes a set of CADC session data that includes data related to the data set, and a classification engine to automatically classify defects in the data set.

In another aspect of the present invention, the defect result file and at least one defect vector relate to semiconductor fabrication.

In another aspect of the present invention, the remote defect inspection tool includes a signal-based tool.

In another aspect of the present invention, a remote manual classification system is provided including at least one tool handler to receive a defect result file and at least one image file from a remote defect inspection tool, a process controller to create a data set from the defect result file and the at least one image file, a re-detection engine to automatically detect defects, a database that includes a set of CADC session data that includes data related to the automatically detected defects, and a remote station wherein manual classification of defects in the data set is performed.

In another aspect of the present invention, the defect result file is a classified defect result file and the manual classification that includes verification of the classified defect result file.

Another aspect of the present invention further includes a classification engine and the manual classification includes verification of the classified defect result file.

In another aspect of the present invention, the re-detection engine marks the defect.

In another aspect of the present invention, the set of CADC session data that includes reference images.

In another aspect of the present invention, an automated monitoring system is provided including a production automatic defect classification (ADC) system, a monitoring CADC, and a monitor process to compare the defect result files of said production ADC system and said monitoring CADC.

In another aspect of the present invention, the defect result file relates to a semiconductor fabrication production line.

In another aspect of the present invention, the production ADC system is a production CADC system.

In another aspect of the present invention, the monitoring process creates an alarm.

In another aspect of the present invention a method for central automated defect classification is provided including, receiving a defect result file from a remote defect inspection tool, accessing image files associated with the defect result file, creating a data set from the defect result file and the image files, retrieving CADC session data that includes data related to the data set, automatically classifying the defects in the image files, and updating the defect result file.

In another aspect of the present invention, automatically classifying further includes re-detecting.

In another aspect of the present invention, the re-detecting further includes feature extracting.

In another aspect of the present invention, the accessing further includes accessing difference image files.

In another aspect of the present invention, the automatically classifying further that includes raising an alarm on significant tool variation.

In another aspect of the present invention, the receiving is from a semiconductor fabrication production line.

In another aspect of the present invention, the accessing is locally from a tool handler.

In another aspect of the present invention, the accessing is from the remote defect inspection tool.

Another aspect of the present invention further includes notifying of a missing CADC recipe.

In another aspect of the present invention a central automated defect classification method is provided including receiving a defect result file from a remote defect inspection tool, accessing at least one defect vector associated with the defect result file, creating a data set from the defect result file and the at least one defect vector, retrieving CADC session data that includes data related to the data set, automatically classifying the defects in the image files, and updating the defect result file.

In another aspect of the present invention, the receiving is from a signal-based tool.

In another aspect of the present invention a remote manual classification method is provided including receiving a defect result file from a remote defect inspection tool, accessing image files associated with the defect result file, creating a data set from the defect result file and the image files, automatically re-detecting the defects in the image files, retrieving CADC session data that includes data related to the data set, and manually classifying the defects.

In another aspect of the present invention, the defect result file is a classified defect result file and the manually classifying includes verifying the classified defect result file results.

Another aspect of the present invention further includes automatically classifying the defects and wherein said manually classifying that includes verifying the classified defect result file results.

In another aspect of the present invention, the automatically re-detecting that includes marking the defect.

In another aspect of the present invention, the data related to the data set that includes reference images.

In another aspect of the present invention an automated monitoring method is provided including receiving an updated defect result file and images, creating a classified defect result file using a special monitoring CADC recipe, and comparing the updated defect result file and the classified defect result file.

In another aspect of the present invention, the receiving is from a semiconductor fabrication production line.

In another aspect of the present invention, the receiving further includes generating an updated defect file from a regular CADC recipe.

Another aspect of the present invention further includes creating an alarm.

### BRIEF DESCRIPTION OF THE DRAWINGS

The present invention will be understood and appreciated more fully from the following detailed description taken in conjunction with the appended drawings in which:

FIG. 1 is a block diagram illustration of a prior art defect classification system;

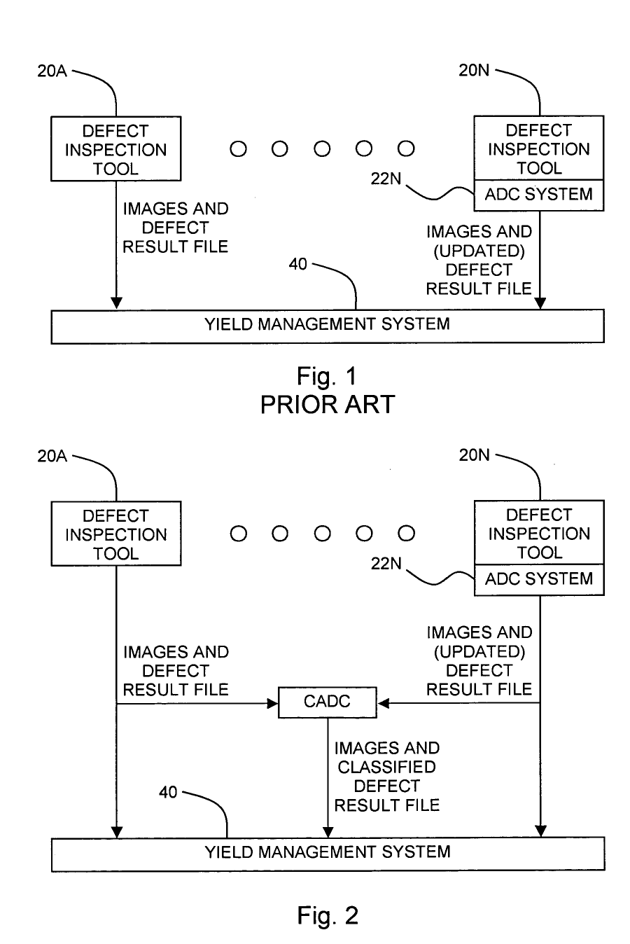

FIG. 2 is a high-level block diagram illustration of a central automatic defect classification system, operative in accordance with a preferred embodiment of the present invention;

FIG. 3 is a further block diagram illustration of the defect classification system of FIG. 2, operative in accordance with a preferred embodiment of the present invention;

FIGS. 4A and B are simplified flowchart illustrations of the functionality of the active and passive tool handlers of FIG. 3 (respectively) for automatic defect classification, operative in accordance with a preferred embodiment of the present invention;

FIG. 5 is a simplified flowchart illustration of the functionality implemented by the process controller of FIG. 3 for automatic defect classification, operative in accordance with a preferred embodiment of the present invention;

FIG. 6A is a block diagram illustration of the defect classification system of FIG. 3, further comprising a monitoring system, operative in accordance with a preferred embodiment of the current invention; and

FIG. 6B is a schematic illustration of a correlation matrix usable in the monitoring system of FIG. 6A, operative in accordance with a preferred embodiment of the present invention.

### DETAILED DESCRIPTION OF PREFERRED EMBODIMENTS

Applicants have designed a system and method providing centralized, off-tool, remote automatic detection and/or classification and/or monitoring of defect images intended for high volume yield sensitive production environments such as semiconductors, flat panel displays (FPD), printed circuit boards (PCB) and magnetic heads for discs. This may provide generally more consistent results on different tools due to the uniform re-detection, feature extraction, and classification algorithms used. Additionally, the system and method of the present invention may reduce handling complexity and significantly shorten the learning curve, as there is a single system to learn to operate. Furthermore, as the system may be centralized and off-tool, proximity to the production area is not necessary and it may allow increased utilization of the inspection and/or review tools. For semiconductor fabrication, for example, the system may be located outside the clean room.

In the description hereinbelow, defect classification in the field of semiconductor fabrication is used as an exemplary non-limiting application, for clarification purposes. Other applications are possible and are included within the scope of the present invention, for example, in microelectronics such as FPDs PCBs and magnetic heads for disc drives. Furthermore, photo-tools used in these industries are included within the scope of the present invention, for example, mask in the field of semiconductors.

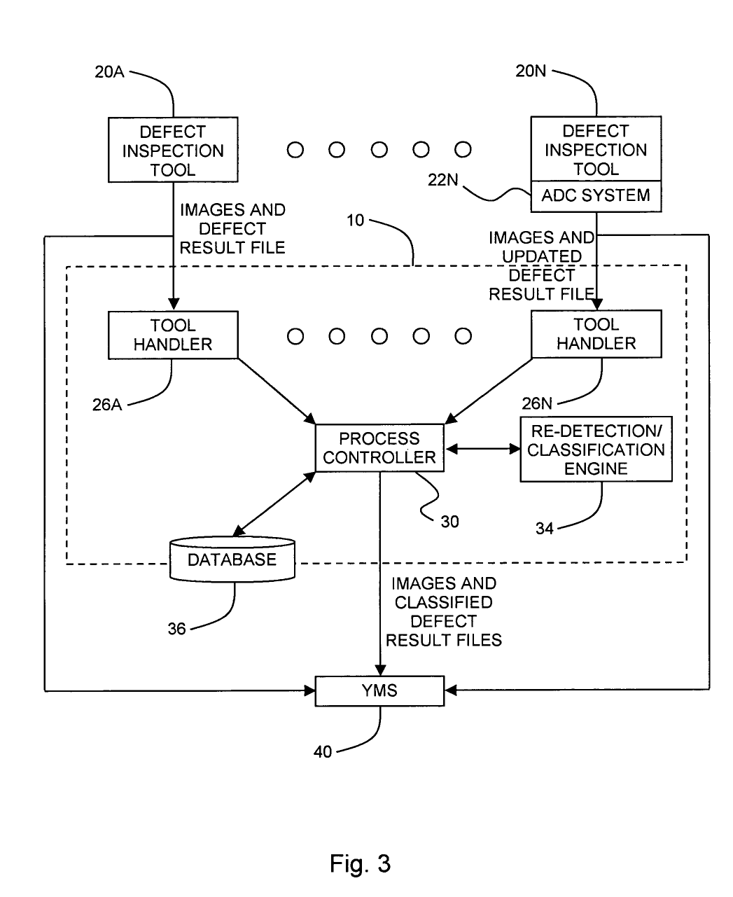

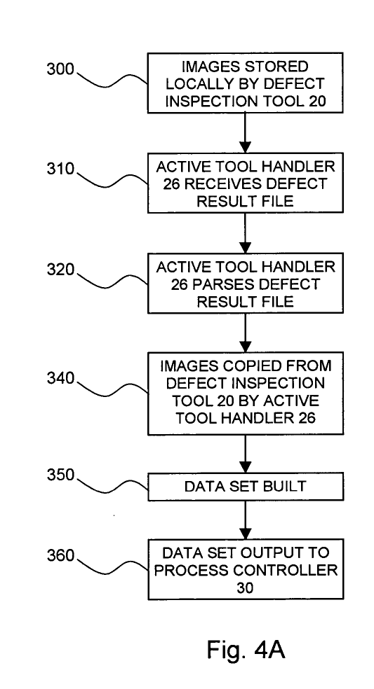

Reference is now made to FIG. 2, a high-level block diagram illustration of a defect classification system, which may comprise at least one defect inspection and/or review tool 20 (hereinbelow defect inspection tool 20), a central automated defect classification system (CADC) 10, and a yield management system (YMS) 40, operative in accordance with a preferred embodiment of the present invention. Defect inspection tool 20 may further comprise an automated defect classification (ADC) system 22. Defect inspection tools 20, CADC 10, and YMS 40 may be operatively connected, for example, via a local or wide area network to allow information transfer. Defect inspection tool 20 may generate images and a corresponding defect result file, which may be output to CADC 10 and/or YMS 40. As described in detail hereinbelow, with respect to FIG. 3, CADC 10 may detect, extract features, and/or classify the defects in the images, may produce a classified defect result file, and may export sample defect images and the classified defect result file to YMS 40.

Defect inspection tool 20 may comprise any appropriate tool known in the art, for example, it may use imaging technology and tool types may comprise any of: an optical review tool, a SEM review tool, a UV review tool, a deep UV (DUV) review tool, a bright field review tool, an optical inspection tool, a SEM inspection tool, a UV inspection tool, a DUV inspection tool, and a bright field inspection tool.

Defect inspection tool 20 output may comprise two components: images and a defect result file. Images may be of any resolution, format, magnification and color (including grey level), typically provided by such review and inspection tools. Defect result files may comprise defect data and may adhere to any appropriate, known, standard format. In a non-limiting example from the field of semiconductor defect classification, defect inspection tool 20 may be an optical review tool, a SEM review tool, an inspection tool, or any other tool known in the art. Images may comprise defect images (DI) and/or reference images (RI). Defect result files may comprise standard defect files known in the art conforming to any known format and the defect data may be unclassified, partly classified, or fully classified.

Defect detection tools 20A-N may be comprised of any mix of tool types from different manufacturers, using different technologies, operating systems, and so forth. Defect inspection tool 20 may or may not comprise ADC system 22. Such an ADC system 22 may comprise software and/or hardware adapted to the specific defect inspection tool 20. Such vendor supplied automated defect classification tools may be created by the vendor or may be licensed or otherwise obtained from independent suppliers.

Defect inspection tool 20 may be operatively connected to CADC 10 via the existing network and after allowing CADC 10 the proper network administrative permissions. Operation of defect inspection tool 20 may not need to be modified to accommodate CADC 10. Thus, integration into an existing environment may be achieved by adding CADC 10 to the network as if it were another network resource. No changes need be made to the existing configuration or other network resources. Hence, defect inspection tool 20 may continue to output images and a defect result file to YMS 40.

In cases where defect inspection tool 20 comprises ADC system 22, CADC 10 may be ignored and the classification results of ADC system 22 may continue to be sent to YMS 40. Hence, defect inspection tool 20 may continue to operate as before and the existence of CADC 10 may be transparent to it. Alteratively, ADC system 22 may not be activated and instead, the computationally complex processes may be transferred to CADC 10 from defect inspection tool 20, which may improve utilization time on defect inspection tool 20.

CADC 10 may re-detect, extract features, and classify each of the defects visited by defect inspection tool 20. CADC 10 may update the defect result file with the appropriate classification identifier, for example by entering a code, a name, or any other identifying data. CADC 10 may output pre-selected images and the updated defect result file to YMS 40.

YMS 40 may be comprised of any appropriate YMS known in the art. YMS 40 may receive a classified defect result file and possibly pre-selected images from CADC 10. Alternatively, YMS 40 may receive pre-selected images (possibly including all images) and a classified, partially classified, or unclassified defect result file directly from any of defect detection tools 20 that include a vendor supplied ADC system. Finally, YMS 40 may receive images and an unclassified defect result file directly from any of defect detection tools 20. Pre-selected images may include those of a specific class of interest, for example, classes designated as “killer defects” (e.g. bridge pattern, open line etc.), “unknown” or “cannot determine”.

In a preferred embodiment of the present invention, CADC 10 may be used to perform remote manual classification on images, which may have been generated, by any of the remote inspection tools 22. CADC 10 may not perform classification of the defects. CADC 10 may perform only re-detection. CADC 10 may further comprise a user workstation, which may be used to present defect images and/or reference images. CADC 10 may still further mark the defect, for example by drawing an ellipse around the defect. This may provide an improved environment to manually review and classify defect. As the interface may be at a remote location, as hereinabove, proximity to the production line may not be necessary. For example, in semiconductor fabrication, the remote location may be outside the clean room.

Further, in a preferred embodiment of the present invention, wherein CADC 10 comprises an ADC system 22N from which classification results were obtained, CADC 10 may be used for manual, on-line verification of the classification results of ADC system 22N. Manual classification using CADC 10 may be performed in a single defect mode (defect by defect) whereby the user may review each defect image and its respective automatically classified type, and may either confirm or decline the classification and may instead enter his own. For example, acceptance may be the default, wherein no action may be required and entry of a different classification may override the automated classification.

In a still further embodiment of the present invention, the classification results of CADC 10 itself may be verified using the method hereinabove.

Summing up the data flow, defect inspection tool 20 may automatically run and collect images from a sampling of production products, for example, semiconductor wafers. The related images may be stored in a predefined disk location. At the end of the production cycle, the respective defect result file may be output to CADC 10. CADC 10 may retrieve the images if they were not stored locally

CADC 10 may perform classification and update the defect result file with classification identifiers. Once completed, CADC 10 may output pre-selected images and the defect result file, now classified to YMS 40.

Reference is now made to FIG. 3, which is a further block diagram illustration of the defect classification system of FIG. 2, providing further details of CADC 10, operative in accordance with a preferred embodiment of the present invention. CADC 10 may comprise at least one tool handler 26, a process controller 30, and a re-detection and/or classification engine 34. CADC 10 may be operatively connected to at least one defect inspection tool 20, a database 36, and to YMS 40. CADC 10 may optionally comprise all, a part, or none of database 36, which may be any appropriate database product known in the art.

As mentioned hereinabove with respect to FIG. 2, as defect detection tools 20 may output images and defect result files of any appropriate standard, there may be one dedicated tool handler 26 allocated and registered per defect inspection tool 20. Each tool handler 26 may be responsible for handling the output associated with a given defect inspection tool 20 that may output data to CADC 10. The defect result file may contain information necessary for classification, for example, information that enables identification of the nature of the images, the product and/or product part, product manufacturing specifics, etc. Tool handler 26 may comprise data conversion capabilities, data verification capabilities, error handling capabilities, the ability to check the availability of images and the defect result file, the ability to parse a defect result file and extract information therein required for classification, and to inform process controller 30 that a “data set” (a ready to process job) may be ready for processing. Hereinbelow, a data set is defined as being comprised of images and a defect result file.

Two types of tool handlers 26 may be possible, a passive or an active tool handler. Passive tool handler 261 may be used with any defect inspection tool 201 which may comprise the capability of storing images at a remote location over the network. In a preferred embodiment of the present invention passive tool handler 26 may further comprise a disk storage area able to receive images from defect inspection tool 20.

Active tool handler 26J may be used with any defect inspection tool 20J which may not comprise the capability of storing images over the network. Such a defect inspection tool 20J may only comprise the capability to store images locally, for example, on a local hard drive. In a preferred embodiment of the present invention active tool handler 26J may further comprise a disk storage area and the ability to access and copy data from the local storage of defect inspection tool 20J, to its own disk storage area.

As the defect result file may be output by defect inspection tool 20 after its operation is complete, in a preferred embodiment of the present invention, the receipt of a defect result file may be interpreted as an “end of data” flag. It may further be understood that all the images associated with this defect result file have been stored either on defect inspection tool 20 or on passive tool handler 26. Tool handler 26 may create a data set, which may be comprised of the images and the defect result file, which it may output to process controller 30.

Database 36 may comprise information required for automatic classification, for example, tool description information, product relevant information, and classification information. Defect detection tools 20 may operate in numerous optical and hardware settings which may cause the output images to change in appearance (for example, gray level) and resolution (for example, pixel size). Hence, tool description information may include two components: information about tool characteristics (per tool type) and specific details regarding the setup and configuration of the tool for the specific product currently being inspected. Product relevant information may include details of the specific product and/or product part represented in the images and the specific process used by each of the products handled by the system. For example, the product may be a semiconductor device and the process used may refer to the level and phase of the manufacturing process. The tool description information and product relevant information may be provided by the user manually and/or automatically, for example, by defect inspection tool 20. Classification information may provide for example, reference images and information relating to manual classification results, images which may be used in classification teaching and tuning, images for verification and monitoring and classification rules. Hereinbelow, “CADC recipe” is defined as comprising tool description information, product relevant information, and classification information for a specific tool and product. Database 36 may be used and modified through the network manually or automatically, by a user or a process.

Process controller 30 may receive data from any tool handler 26. Process controller 30 may perform additional data conversion as necessary, on the contents of any received defect result file in a data set. Process controller 30 may prioritize the data sets received and may control the processing of re-detection and/or classification engine 34. For example, process controller 30 may treat the data sets as batch data, to be processed according to a predefined priority.

Process controller 30 may retrieve the necessary CADC recipe from database 36 and may output it to re-detection and/or classification engine 34 with the data set.

Re-detection and/or classification engine 34 may receive the data set and the necessary CADC recipe from process controller 30. The CADC recipe may be used in determining classification. Re-detection and/or classification engine 34 may be any ADC system known in the art capable of performing automatic defect classification, such as, but not limited to, the DCS-3 available from MicroSpec Technologies Ltd. of Yokneam, Israel.

When results are available from re-detection and/or classification engine 34, the defect result file (or updated result file) may be modified with the classification information by process controller 30, creating a “classified defect result file”. Finally, the sample images and classified defect result files may be sent to YMS 40 using a dedicated interface.

In a preferred embodiment of the present invention, CADC 10 may comprise the ability to perform remote classification wherein re-detection may not be necessary. Defect inspection tool 20 may be an inspection only tool wherein a defect result file is produced as described hereinabove. However, the images output may include difference images as well as defect images. Difference images may be comprised of binary files with only the actual defect information provided (defect mask). As only the image of the defect itself may be represented, re-detection may not be necessary; only feature extraction and classification may be performed.

In a preferred embodiment of the present invention, CADC 10 may comprise the ability to perform remote classification wherein re-detection and feature extraction may not be necessary. Defect inspection tool 20 may be an inspection tool wherein a defect result file is produced as described hereinabove. However, instead of images being output, a vector representing the defect data (defect vector) is generated. There may be no images in such a preferred embodiment. As the vector may comprise defect data, re-detection and feature extraction may not be necessary, only classification may be performed. Defect inspection tool 20 may be any signal-based tool known in the art, for example, defect inspection tool 20 may employ laser scattering technology.

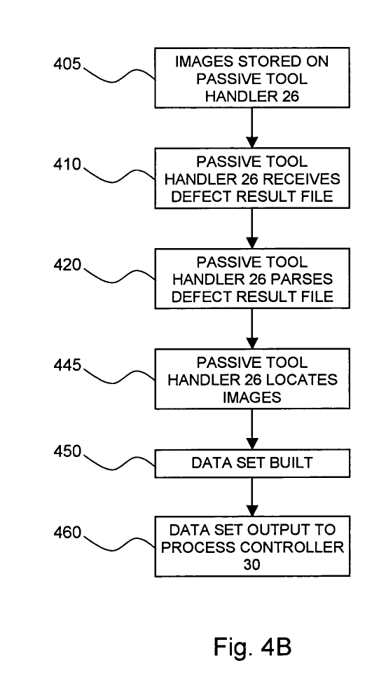

Reference is now made to FIGS. 4A and B, which are simplified flowchart illustrations of the functionality of active and passive tool handlers 26 of FIG. 3, operative in accordance with a preferred embodiment of the present invention. As mentioned hereinabove with respect to FIG. 3, active tool handler 26 may retrieve images stored on defect inspection tool 20 whereas passive tool handler 26 may have images stored directly to its disk storage area over the network by defect inspection tool 20.

Referring to FIG. 4A and active tool handler 26, defect inspection tool 20 may store images locally as they are acquired or produced (step 300). When the inspection or review cycle of the sample set is complete, defect inspection tool 20 may send a defect result file to active tool handler 26. This receipt of a defect result file may be interpreted as an “end of data” flag (step 310). Active tool handler 26 may parse the defect result file and may extract information therein required for classification (step 320). It may further perform data verification and error handling. Active tool handler 26 may copy the images from the data storage area of defect inspection tool 20 (step 340) and may then build a data set comprising the images and defect result file (step 350). The data set may be input to process controller 30 (step 360).

Referring to FIG. 4B and passive tool handler 26, images may be stored on passive tool handler 26 by defect inspection tool 20 as they are acquired or produced (step 405). When the inspection or review cycle of the sample set is complete, defect inspection tool 20 may send a defect result file to passive tool handler 26. This receipt of a defect result file may be interpreted as an “end of data” flag (step 410). Passive tool handler 26 may parse the defect result file and may extract information therein required for classification (step 420). It may further perform data verification and error handling. Passive tool handler 26 may locate the image set on its local data storage area (step 445) and may then build a data set comprising the images and defect result file (step 450). The data set may be input to process controller 30 (step 460).

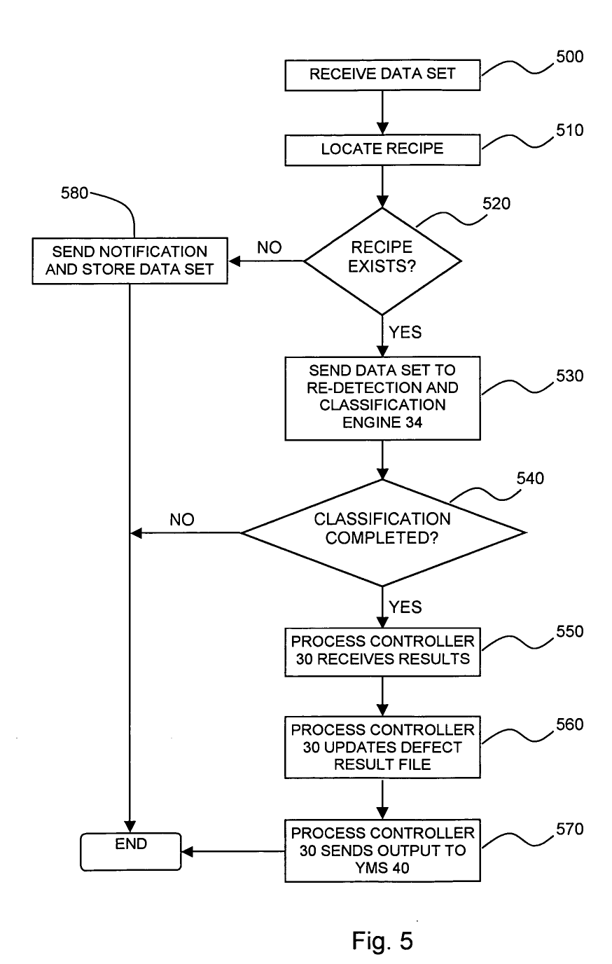

FIG. 5, to which reference is now made, is a simplified flowchart illustration of the functionality of process controller 30 of FIG. 3, operative in accordance with a preferred embodiment of the present invention. Process controller 30 may receive a data set from any of tool handlers 36 (step 500) and may locate the recipe associated with the data set (step 510).

If a CADC recipe is found (step 520), the data set is sent to re-detection and/or classification engine 34 (step 530). If defect classification was not completed successfully (step 540), the process may be terminated and a system alarm may be raised. If defect classification was successfully completed (step 540), process controller 30 may receive classification results from re-detection and/or classification engine 34 (step 550). Process controller 30 may update the defect result file creating a classified defect result file (step 560). Process controller 30 may output pre-selected images and the classified defect result file to YMS 40 (step 570) completing the processing.

However, if a CADC recipe is not found (step 520), a CADC recipe must be created before classification may begin. Hence, notification may be sent requesting that a CADC recipe be created. The data set may be stored, possibly in re-detection and/or classification engine 34, for later processing (step 580) and the process may be terminated.

In semiconductor wafer fabrication environments, the performance of ADC systems generally deteriorate over time due to the inherent limitations of the initial recipes which may have been based on a narrow spectrum of data Such recipes cannot encompass the entire space of defect population since it is unpredictable due to process variations and defect evolution. Therefore, both classification accuracy and purity may tend to degrade with time. Most semiconductor fabrication facilities, which use ADC systems, employ a human monitoring policy according to which, once every predefined period of time, once per predefined number of lots or of wafers, defects are manually classified and compared to the classification results of the ADC system. The accuracy and purity may be calculated over these defects. If the results drop below a certain level (user settable), then the ADC system may be retrained (generating a new recipe) or fine-tuned (if the ADC system allows such modifications).

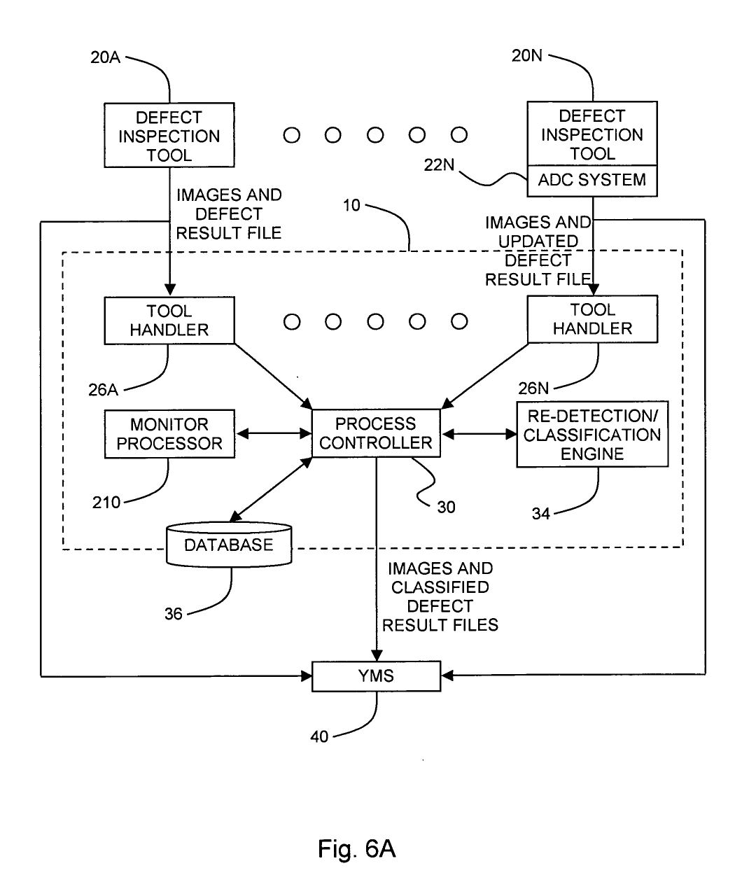

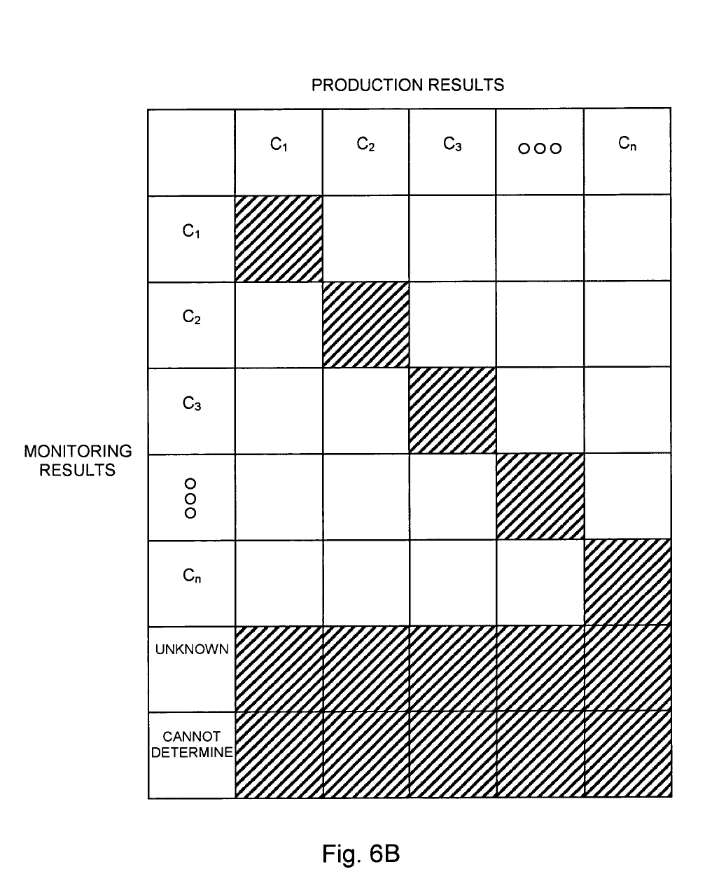

FIG. 6A, to which reference is now made, is a block diagram illustration of a monitoring system, operative in accordance with a preferred embodiment of the current invention. The monitoring system may comprise CADC 10 of FIG. 3, which may further comprise a monitoring processor 210. The description and functionality of the components of CADC 10 appearing in FIG. 3 and re-appearing in FIG. 6A are identical. CADC 10 may be operatively connected to at least one defect detection tool 20N comprising ADC system 22N.

Defect inspection tool 20N may classify defects as they are detected and may produce a first classified defect result file and images which may be sent to process controller 30 as described hereinabove with respect to FIG. 3. Process controller 30 may retrieve a special monitoring CADC recipe. At possibly predetermined intervals of possibly predetermined length, monitor processor 210 may instruct CADC 10 to perform classification. Alternatively, CADC 10 may perform classification continually. CADC 10 may classify the images which may have been classified by defect inspection tool 20N and may produce a second set of classification results which may either be added to the first classified defect result file or stored in a second cloned classified defect result file.

Monitor processor 210 may compare the two classification results and may use the classification results produced by CADC 10 with the special monitoring CADC recipe, as a reference against which the results of defect inspection tool 20N may be measured for accuracy and purity, which may be used as a monitored performance parameter. CADC 10 and defect inspection tool 20N may use different CADC recipes that may have been generated from the same original data. As the classification engines are different, there may be differences in the classification results. If the monitored performance parameter exceeds a predetermined alarm value, a warning message may be produced which may indicate corrective action. Hence, the CADC 10 classification results may be used instead of manual classification, allowing automatic monitoring.

In a preferred embodiment of the present invention, CADC 10 may be operatively connected to at least one defect detection tool 20A which does not comprise an ADC system. CADC 10 may comprise the ability to handle more than one CADC recipe at the same time. Process controller 30 may retrieve the regular CADC recipe used for classification. The classification results produced by CADC 10 using the regular CADC recipe may be designated as the production classification results. Process controller 30 may also retrieve the special monitoring CADC recipe. As described, CADC 10 may use the special monitoring CADC recipe to produce classification results, which may be designated as the monitoring classification results.

Monitor processor 210 may compare the two classification results and may use the monitoring classification results, as a reference against which the production classification results may be measured for accuracy and purity, which may be used as a monitored performance parameter. As described, if the performance parameter exceeds a predetermined alarm value a warning message may be produced which may indicate corrective action.

Using the monitoring system of FIG. 6A, monitoring of ADC performance across a production line may be performed automatically, and human intervention if needed may be initiated by an alarm. As long as any monitored parameter does not exceed the alarm value, no action is taken. If, however a monitored value exceeds the alarm value, a warning signal may be produced. In the semiconductor field, parameters of interest may include any of classification accuracy or purity, for any specific pre selected defect category (class) or the entire population.

Reference is now made to FIG. 6B, which is a schematic illustration of a correlation matrix, operative in accordance with a preferred embodiment of the present invention. The correlation matrix (known also as a “confusion matrix”) may sum up the performance results per class and the overall results by comparing the classification results produced by two automatic classification methods. Each entry in the matrix (Ci, Cj) may represent the total number of defects (out of the entire monitored population) that have been classified as Ci by the monitoring system and Cj by the production classification system, thus, indicating misclassification (by either system). As described, monitoring results may be generated by CADC 10 using the special monitoring CADC recipe, while the production results may be generated by either defect inspection tool 20N or CADC 10 using the regular CADC recipe used for classification.

The entries along the diagonal (Ci, Ci) represent the number of defects that have been classified identically by both automatic classification systems may indicate a good classification or a match. The entries in the bottom two rows, marked as “unknown” and “cannot determine” may represent defects that were identified by the production recipe, but the monitoring recipe was unable to classify.

The final results may be tabulated in a list from which an alarm decision could be easily calculated. Furthermore, a report may be generated.

The present invention is thus advantageous over the prior art in that it may provide a standalone automatic classification system, which may be able to perform tasks and services from a remote, central location and may provide more precise and consistent classification of the defects. In the field of semiconductor fabrication, the remote system may be located outside the clean room, which may introduce less contamination into the clean room and provide a more convenient environment for operators who may interact with the system. The centralized system of the present invention may outweigh any distributed, tool-oriented alternative in its overall performance, which may be reflected in data consistency and throughput (tool utilization). Furthermore, it may provide a low cost system as only one classification system may need to be purchased. The ownership cost of a centralized system may be lower due to decreased expenses related to training and maintenance of multiple systems.

It is appreciated that one or more of the steps of any of the methods described herein may be omitted or carried out in a different order than that shown, without departing from the true spirit and scope of the invention.

While the methods and systems disclosed herein may or may not have been described with reference to specific hardware or software, it is appreciated that the methods and systems described herein may be readily implemented in hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A central automated defect classification system comprising:
at least one tool handler to receive a defect result file and at least one image file from a remote imaging technology defect inspection tool;
a process controller to create a data set from the defect result file and the at least one image file;
a database comprising a set of CADC session data comprising data related to the data set; and
a classification engine to automatically classify defects in the data set.

2. A system according to claim 1, wherein said classification engine is a re-detection and classification engine.

3. A system according to claim 2, wherein said classification engine performs feature extraction.

4. A system according to claim 1, wherein said at least one image file further comprises a corresponding difference image file.

5. A system according to claim 1, wherein the defect result file and at least one image file are of semiconductor fabrication.

6. A system according to claim 1, wherein for each remote defect inspection tool there is a dedicated tool handler.

7. A system according to claim 1, wherein said at least one tool handler is passive.

8. A system according to claim 1, wherein said at least one tool handler is active.

9. A system according to claim 1, wherein the remote defect inspection tool is selected from the group consisting of: an optical review tool, a SEM review tool, a UV review tool, a deep UV (DUV) review tool, a bright field review tool, an optical inspection tool, a SEM inspection tool, a UV inspection tool, a DUV inspection tool, and a bright field inspection tool.

10. A central automated defect classification system comprising:
at least one tool handler to receive a defect result file and at least one defect vector from a remote defect inspection tool;
a process controller to create a data set from the defect result file and the at least one defect vector;
a database comprising a set of CADC session data comprising data related to the data set; and
a classification engine to automatically classify defects in the data set.

11. A system according to claim 10, wherein the defect result file and at least one defect vector are of semiconductor fabrication.

12. A system according to claim 10, wherein the remote defect inspection tool comprises a signal based tool.

13. A remote manual classification system comprising:
at least one tool handler to receive a defect result file and at least one image file from a remote imaging technology defect inspection tool;
a process controller to create a data set from the defect result file and the at least one image file;
a re-detection engine to automatically detect defects;
a database comprising a set of CADC session data comprising data related to the automatically detected defects; and
a remote station wherein manual classification of defects in the data set is performed.

14. A system according to claim 13, wherein the defect result file is a classified defect result file and the manual classification comprises verification of the classified defect result file.

15. A system according to claim 13, further comprising a classification engine, and wherein the manual classification comprises verification of the classified defect result file.

16. A system according to claim 13, wherein said re-detection engine marks the defect.

17. A system according to claim 13, wherein the set of CADC session data comprises reference images.

18. A system according to claim 13, wherein said at least one tool handler is on a semiconductor fabrication production line.

19. A system according to claim 13, wherein the remote defect inspection tool comprises any tool type selected from the group consisting of: an optical review tool, a SEM review tool, a UV review tool, a DUV review tool, a bright filled inspection tool, an optical inspection tool, a SEM inspection tool, a UV inspection tool, a DUV inspection tool, and a bright filled inspection tool.

20. An automated monitoring system comprising:
a production ADC system;
a monitoring CADC; and
a monitor process to compare the defect result files of said production ADC system and said monitoring CADC.

21. A system according to claim 20, wherein the defect result file relates to a semiconductor fabrication production line.

22. A system according to claim 20, wherein said production ADC system is a production CADC system.

23. A system according to claim 20, wherein said monitoring process creates an alarm.

24. A method for central automated defect classification comprising:
receiving a defect result file from a remote defect inspection tool;
accessing image files associated with the defect result file;
creating a data set from the defect result file and the image files;
retrieving CADC session data comprising data related to the data set;
automatically classifying the defects in the image files; and
updating the defect result file.

25. A method according to claim 24, wherein said automatically classifying further comprises re-detecting.

26. A method according to claim 25, wherein said re-detecting further comprises feature extracting.

27. A method according to claim 24 wherein said accessing further comprises accessing difference image files.

28. A method according to claim 24, wherein said automatically classifying further comprises raising an alarm on significant tool variation.

29. A method according to claim 24, wherein said receiving is from a semiconductor fabrication production line.

30. A method according to claim 24, wherein for each remote defect inspection tool there is a dedicated tool handler.

31. A method according to claim 24, wherein said accessing is locally from a tool handler.

32. A method according to claim 24, wherein said accessing is from the remote defect inspection tool.

33. A method according to claim 24, and further comprising notifying of a missing CADC recipe.

34. A central automated defect classification method comprising:
receiving a defect result file from a remote defect inspection tool;
accessing at least one defect vector associated with the defect result file;
creating a data set from the defect result file and the at least one defect vector;
retrieving CADC session data comprising data related to the data set;
automatically classifying the defects in the image files; and
updating the defect result file.

35. A method according to claim 34, wherein said receiving is from a semiconductor fabrication production line.

36. A method according to claim 34, wherein said receiving is from a signal based tool.

37. A remote manual classification method comprising:
receiving a defect result file from a remote defect inspection tool;
accessing image files associated with the defect result file;
creating a data set from the defect result file and the image files;
automatically re-detecting the defects in the image files;
retrieving CADC session data comprising data related to the data set; and
manually classifying the defects.

38. A method according to claim 37, wherein the defect result file is a classified defect result file and said manually classifying comprises verifying the classified defect result file results.

39. A method according to claim 37, further comprising automatically classifying the defects and wherein said manually classifying comprises verifying the classified defect result file results.

40. A method according to claim 37, wherein said automatically re-detecting comprises marking the defect.

41. A method according to claim 37, wherein the data related to the data set comprises reference images.

42. A method according to claim 37, wherein said receiving is from a semiconductor fabrication production line.

43. An automated monitoring method comprising:
receiving an updated defect result file and images;
creating a classified defect result file using a special monitoring CADC recipe; and
comparing the updated defect result file and the classified defect result file.

44. A method according to claim 43, wherein said receiving is from a semiconductor fabrication production line.

45. A method according to claim 43, wherein said receiving further comprises generating an updated defect file from a regular CADC recipe.

46. A method according to claim 43, further comprises creating an alarm.
